(19) United States
(12) Patent Application Publication
(10) Pub. No.: US 2017/0237062 A1
(43) Pub. Date: Aug. 17, 2017

(54) PRODUCTION METHOD FOR ELECTRODE PLATE

(71) Applicant: TOYOTA JIDOSHA KABUSHIKI KAISHA, Toyota-shi (JP)

(72) Inventors: Kunihiko HAYASHI, Anjo-shi (JP); Tomoyuki UEZONO, Okazaki-shi (JP)

(21) Appl. No.: 15/432,685

(22) Filed: Feb. 14, 2017

(30) Foreign Application Priority Data
Feb. 15, 2016 (JP) 2016025862

(51) Int. Cl. H01M 4/04; B29C 43/24; H01M 4/133; H01M 4/62; H01M 10/0525; H01M 4/66

(52) U.S. Cl. CPC H01M 4/0435; H01M 10/0525; H01M 4/661; H01M 4/133; H01M 4/623; B29C 43/24; H01M 2004/027

(57) ABSTRACT

An electrode plate is produced by a wet granule forming process and a film forming process. In the wet granule forming process, wet granules are formed by mixing electrode mixture materials including at least an active material and a binder with a solvent. In the film forming process, a sheet-shaped electrode mixture layer is formed by causing the wet granules to pass through a gap between a pair of rolls so as to be rolled, and the electrode mixture layer is adhered onto a current collector foil. In the wet granule forming process, a powder of copper having an average particle size of 100 nm or smaller is used as one of the electrode mixture materials, and the amount of the powder of copper added in a range of 0.05 wt % to 2.00 wt % with respect to the total weight of the electrode mixture materials.

### INCORPORATION BY REFERENCE

This application claims priority to Japanese Patent Application No. 2016-025862 filed on Feb. 15, 2016, which is incorporated by reference in its entirety including the specification, drawings and abstract.

### BACKGROUND

1. Technical Field

The disclosure relates to a method for producing an electrode plate of a battery.

2. Description of Related Art

A battery, such as a lithium-ion secondary battery, is formed by accommodating positive and negative electrode plates and an electrolyte in a case. As the positive and negative electrode plates, those having a configuration with a current collector foil and an electrode mixture layer provided on the surface of the current collector foil are used. In addition, the electrode mixture layer includes electrode mixture materials such as an active material and a binder. A production method of such an electrode plate is described in, for example, Japanese Patent Application Publication No. 2015-178093 (JP 2015-178093 A).

In JP 2015-178093 A, a technique for producing a coated material by rolling a coating material including a solvent using a pair of rolls and transferring the rolled coating material onto a coating object is described. In addition, JP 2015-178093 A discloses examples in which the technique is applied to the production of a negative electrode plate of a lithium-ion secondary battery. That is, negative electrode mixture materials such as a negative electrode active material and a binder are stirred with water as the solvent to be mixed with each other, thereby producing a negative electrode mixture paint. In addition, the produced negative electrode mixture paint is rolled by the pair of rolls and formed into a coating film (electrode mixture layer), and the coating film is transferred onto a copper foil (current collector foil), thereby producing a negative electrode plate.

However, in a method of forming an electrode mixture layer through rolling using a pair of rolls, it is preferable that the spreadability of a material to be rolled is high. This is because, in a case where a material with insufficient spreadability is used, pinholes or streaky uneven portions are formed in the electrode mixture layer after the rolling. That is, there is concern that an electrode plate which has an electrode mixture layer with a uniform thickness and thus has high quality cannot be produced.

### SUMMARY OF THE DISCLOSURE

The disclosure provides a method for producing an electrode plate where the method is capable of forming an electrode mixture layer with a uniform thickness.

An aspect of the present disclosure relates to a method for producing an electrode plate comprising: forming wet granules by mixing electrode mixture materials including at least a powder containing copper, which is included in a proportion in a range of 0.05 wt % to 2.00 wt % with respect to a total weight of the electrode mixture materials and has an average particle size of 100 nm or smaller, an active material, and a binder, with a solvent; and forming a sheet-shaped electrode mixture layer by passing the wet granules through a gap between a pair of rolls so as to be rolled, and adhering the electrode mixture layer onto a current collector foil, thereby producing an electrode plate having the electrode mixture layer on the current collector foil.

When the wet granules are formed, the powder containing copper having an average particle size of 100 nm or smaller is added in a range of 0.05 wt % to 2.00 wt % with respect to the total weight of the electrode mixture materials. Accordingly, the spreadability of the wet granules can be increased. Therefore, when the film is formed, formation of pinholes or streaky uneven portions in the electrode mixture layer can be prevented. Therefore, the electrode plate including the electrode mixture layer having a uniform thickness can be produced.

A first mixture may be produced by mixing the active material and the powder containing copper with each other. A second mixture may be produced by further mixing the binder and the solvent in the first mixture, and the wet granules are formed by granulating the second mixture. This is because the wet granules in which the powder containing copper is appropriately distributed can be formed by the wet granule forming process. Accordingly, the electrode mixture layer can be formed into a uniform thickness and the conductivity of the formed electrode mixture layer can be increased.

According to the disclosure, the method for producing an electrode plate in which the electrode mixture layer can be formed into a uniform thickness is provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a flowchart showing a procedure for producing a negative electrode plate according to an embodiment;

FIG. 2 is a flowchart showing a procedure for forming wet granules in a wet granule forming process of a first embodiment;

FIG. 3 is a perspective view illustrating a negative electrode plate production apparatus used in a film forming process;

FIG. 4 is a flowchart showing a procedure for forming wet granules in a wet granule forming process of a second embodiment;

FIG. 5 is a graph showing spreadability index values of examples and comparative examples;

FIG. 6 is a graph showing the relationship between the amount of copper added and a spreadability index value;

FIG. 7 is a graph regarding the spreadability index values and resistance values of the examples and the comparative examples;

FIG. 8 is a graph showing the relationship between the amount of copper added and a resistance value; and

FIG. 9 is a graph showing the relationship between the ratio of copper and the resistance value of a negative electrode mixture layer.

### DETAILED DESCRIPTION OF EMBODIMENTS

Hereinafter, embodiments which embody the disclosure will be described in detail with reference to the drawings.

### First Embodiment

In a first embodiment, the disclosure is applied to the production of a negative electrode plate of a lithium-ion secondary battery. The negative electrode plate produced in this embodiment has a negative electrode current collector foil, and a negative electrode mixture layer formed on the surface of the negative electrode current collector foil.

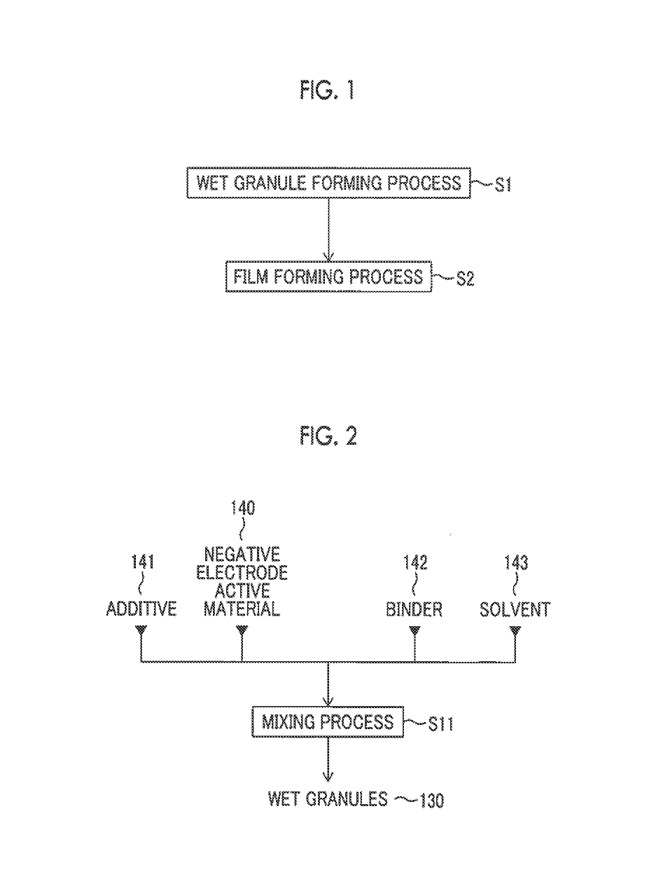

FIG. 1 is a flowchart showing a procedure for producing the negative electrode plate according to this embodiment. As illustrated in FIG. 1, the negative electrode plate of this embodiment is produced by performing a wet granule forming process (S1) and a film forming process (S2) in this order. The wet granule forming process is a process of producing wet granules, which are a material for forming the negative electrode mixture layer of the negative electrode plate. The film forming process is a process of producing the negative electrode plate by adhering the negative electrode mixture layer to the surface of the negative electrode current collector foil.

The wet granule forming process (S1) will be described. FIG. 2 is a flowchart showing a procedure for forming the wet granules in the wet granule forming process. As shown in FIG. 2, in this embodiment, a negative electrode active material 140, an additive 141, and a binder 142, which are negative electrode mixture materials, are used to form wet granules 130. In addition to the negative electrode mixture materials, a solvent 143 is used to form the wet granules 130.

The negative electrode active material 140 is a material that causes occlusion and release of lithium ions in a lithium-ion secondary battery and contributes to charging and discharging. The binder 142 is a material that causes materials included in the negative electrode mixture layer of the negative electrode plate to be bound together and form the negative electrode mixture layer, and causes the negative electrode mixture layer to be bound to the surface of the negative electrode current collector foil. In addition, in this embodiment, specifically, graphite is used as the negative electrode active material 140, styrene-butadiene rubber (SBR) and carboxymethyl cellulose (CMC) are used as the binder 142, and water (deionized water) is used as the solvent 143.

In addition, the additive 141 is a powder including fine particles of copper (Cu). Specifically, as the additive 141, copper powder can have an average particle size of primary particles of 100 nm or smaller. That is, in this embodiment, as one of the negative electrode mixture materials, fine particle powder of copper is used. In addition, in this embodiment, the average particle size is obtained where the median diameter which is a particle size at cumulative 50% in a volume-based particle size distribution acquired by a laser diffraction/scattering method.

In addition, in this embodiment, the amount of the additive 141 added is in a range of 0.05 wt % to 2.00 wt % with respect to the total weight of the negative electrode mixture materials (the negative electrode active material 140, the additive 141, and the binder 142).

In addition, in the wet granule forming process of this embodiment, a mixing process (S11) mixes the negative electrode active material 140, the additive 141, the binder 142, and the solvent 143 together. The mixing process can be performed by supplying the negative electrode active material 140, the additive 141, the binder 142, and the solvent 143 into a stirrer and stirring the mixture. As the stirrer, for example, Food Processor (MB-MM22) manufactured by Yamamoto Electric Corporation may be used. In the mixing process, the negative electrode active material 140, the additive 141, the binder 142, and the solvent 143 are uniformly dispersed in the mixture through stirring by the stirrer.

Furthermore, in the mixing process, as the mixture including the negative electrode active material 140 and the like is stirred, the materials in the mixture are granulated. That is, in the mixing process, the negative electrode active material 140 and the like in the mixture become granules having a larger particle size than the original particle size. These granules are the wet granules 130 including the solvent 143. In addition, in the mixing process, an adjusting process of adjusting the particle size of the granules may be performed on the formed wet granules 130.

In addition, the proportion of the solid contents in the wet granules 130 is preferably 70% or higher. That is, it is preferable that the amount of the solvent 143 is such that the weight of the solid contents such as the negative electrode active material 140 is 70% or more with respect to the weight of the entire mixture. This is because the wet granules 130 are appropriately formed without an excessive amount of solvent 143.

In addition, the proportion of the solid contents in the wet granules 130 is preferably 90% or lower, and more preferably 85% or lower. This is because the wet granules 130 are appropriately formed without causing the solvent 143 to become insufficient.

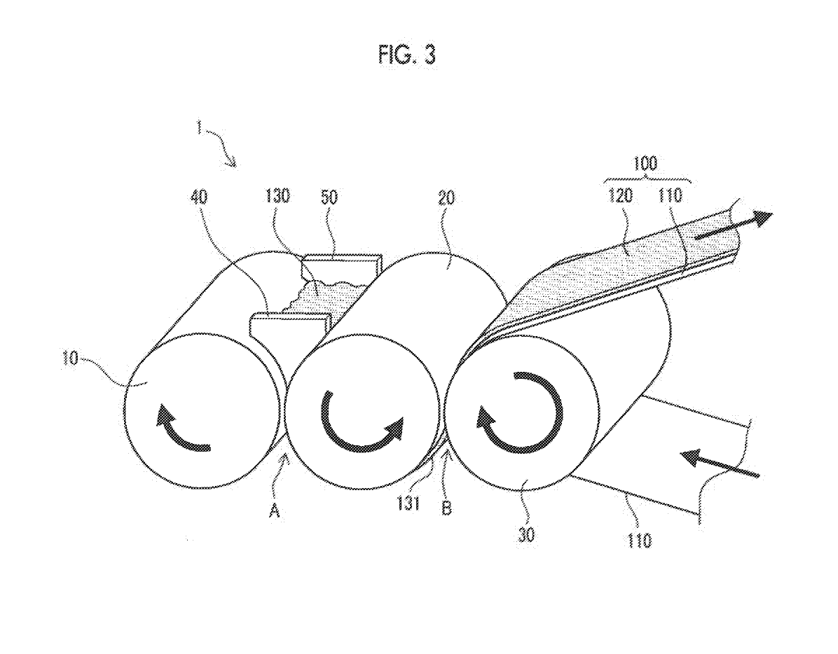

In addition, the film forming process (S2) shown in FIG. 1 is performed using the obtained wet granules 130. FIG. 3 illustrates a film forming apparatus 1 used in the film forming process of this embodiment. The film forming apparatus 1 has a first roll 10, a second roll 20, and a third roll 30. As shown in FIG. 3, in the film forming apparatus 1, these three rolls are horizontally arranged.

In addition, the first roll 10 and the second roll 20 form a pair of rolls where the outer circumferential surfaces face each other at a first facing position A. The second roll 20 and the third roll 30 form a pair of rolls where the outer circumferential surfaces face each other at a second facing position B. In addition, at each of the first facing position A and the second facing position B, a gap is provided between the rolls facing each other.

On the upper side of the first facing position A, partition plates 40 and 50 are respectively provided in the vicinity of both ends in the axial direction of the first roll 10 and the second roll 20. That is, the partition plates 40 and 50 are disposed with an interval therebetween. In addition, the wet granules 130 formed in the wet granule forming process are supplied between the partition plates 40 and 50.

At the second facing position B, a negative electrode current collector foil 110 is wound around the outer circumferential surface of the third roll 30. That is, the negative electrode current collector foil 110 passes through the gap between the second roll 20 and the third roll 30 at the second facing position B. In this embodiment, the negative electrode current collector foil 110 is a copper foil.

In addition, the film forming process is performed by rotating the first roll 10, the second roll 20, and the third roll 30 of the film forming apparatus 1 in predetermined directions indicated by arrows in FIG. 3. Specifically, the first roll 10 and the second roll 20 are both rotated in a direction in which the direction of movement of the outer circumferential surfaces thereof is a vertically downward direction at the first facing position A.

The third roll 30 is rotated in a direction in which the direction of movement of the outer circumferential surface thereof is the same as the movement direction of the outer circumferential surface of the second roll 20 at the second facing position B. In addition, as the third roll 30 is rotated, the negative electrode current collector foil 110 wound around the third roll 30 is transported. That is, as indicated by the arrows in FIG. 3, the negative electrode current collector foil 110 is supplied to the film forming apparatus 1 from the lower right of the third roll 30, passes through the second facing position B, and is thereafter discharged from the film forming apparatus 1 toward the upper right of the third roll 30.

In addition, in the film forming process, the wet granules 130 between the partition plates 40 and 50 pass through the gap between the first roll 10 and the second roll 20 at the first facing position A due to the rotation of the first roll 10 and the second roll 20. When passing through the gap at the first facing position A, the wet granules 130 are pressed and rolled by the first roll 10 and the second roll 20. Through the rolling, the wet granules 130 are formed into a sheet shape at the first facing position A and become a negative electrode mixture layer 131.

Here, in the film forming apparatus 1 of this embodiment, the circumferential speed of the second roll 20 is caused to be faster than the circumferential speed of the first roll 10. That is, the rotational speed of the outer circumferential surface of the second roll 20 at the first facing position A is caused to be faster than the rotational speed of the outer circumferential surface of the first roll 10. Accordingly, the negative electrode mixture layer 131 formed at the first facing position A adheres to the outer circumferential surface of the second roll 20 with a faster rotational speed.

The negative electrode mixture layer 131 adhered to and held on the outer circumferential surface of the second roll 20 is transported by the rotation of the second roll 20 and reaches the second facing position B. The negative electrode mixture layer 131 that reaches the second facing position B passes through the gap between the second roll 20 and the third roll 30 at the second facing position B together with the negative electrode current collector foil 110. When passing through the gap at the second facing position B, the negative electrode mixture layer 131 and the negative electrode current collector foil 110 are pressed in the thickness direction by the second roll 20 and the third roll 30.

Here, in the film forming apparatus 1 of this embodiment, the circumferential speed of the third roll 30 is faster than the circumferential speed of the second roll 20. That is, the movement speed of the negative electrode current collector foil 110 at the second facing position B is caused to be faster than the movement speed of the outer circumferential surface of the second roll 20. Accordingly, the negative electrode mixture layer 131 pressed in the thickness direction at the second facing position B is transferred and adhered onto the surface of the negative electrode current collector foil 110 with a faster movement speed.

Therefore, the negative electrode mixture layer 120 adheres to the negative electrode current collector foil 110 passing through the second facing position B. That is, the negative electrode mixture layer 120 and the negative electrode current collector foil 110 are integrated with each other and formed into a negative electrode plate 100. After the negative electrode plate 100 passes through the second facing position B, the negative electrode plate 100 is discharged from the film forming apparatus 1. In addition, the negative electrode plate 100 discharged from the film forming apparatus 1 is thereafter assembled into the battery. In addition, in this embodiment, before the negative electrode plate 100 is assembled into the battery, a drying process of drying the negative electrode mixture layer 120 is performed. Moreover, in order to adjust the density of the negative electrode mixture layer 120, a pressing process of pressing the negative electrode plate 100 in the thickness direction may be performed. In addition, in a case where the negative electrode mixture layer 120 is formed on both surfaces of the negative electrode current collector foil 110, the negative electrode mixture layer 120 can be formed on the other surface of the negative electrode current collector foil 110 in the same manner.

In the film forming process, as described above, the wet granules including the additive are used. As described above, the additive is a powder of fine particles of copper having an average particle size of 100 nm or smaller. In addition, since the wet granules used in the film forming process of this embodiment include a fine particle powder of copper, high spreadability is achieved. The principle is thought to be as follows.

That is, when the wet granules are rolled, particles of the solid contents in the wet granules come into contact with each other. It is thought that in a case where the contact is direct contact between the particles of the negative electrode active material, the frictional resistance is high. This is because the surface of the particle of the negative electrode active material has uneven portions and is not smooth. That is, it is thought that in a case where the frequency of direct contact between the particles of the negative electrode active material in the rolled wet granules is high, the spreadability is low.

On the other hand, it is thought that in the wet granules including fine particles of copper, fine particles of copper adhere to the surfaces of the negative electrode active material. Accordingly, it is thought that the uneven portions of the surfaces of the negative electrode active material are buried by the fine particles of copper. In addition, in the wet granules including the fine particles of copper, the fine particles of copper are interposed between the particles of the negative electrode active material during rolling. In addition, it is thought that movement of the particles of the negative electrode active material is incurred due to rolling of the interposed fine particles of copper. Therefore, it is thought that the frequency of direct contact between the particles of the negative electrode active material during rolling is low and the particles of the negative electrode active material during the rolling move smoothly. Accordingly, it is thought that in this embodiment, the spreadability of the wet granules is increased.

However, it is not preferable that the amount of the fine particle powder of copper added to the wet granules is too high. This is because in a case where the amount of the fine particle powder of copper added is too high, the spreadability of the wet granules decreases. That is, it is thought that in a case where the amount of the fine particle powder of copper added is high, the fine particles of copper stick together during granulation, resulting in the formation of aggregates with a large particle size, and slipping between the particles in the wet granules is impeded by the aggregates. In addition, naturally, the spreadability cannot be increased in a case where the amount of the fine particle powder of copper added to the wet granules is too low. Therefore, in this embodiment, as described above, the amount of fine particle powder of copper added to the wet granules is set to be in a range of 0.05 wt % to 2.00 wt % with respect to the total weight of the negative electrode mixture materials (the negative electrode active material, the fine particle powder of copper, and the binder). Accordingly, the spreadability of the wet granules of this embodiment can be appropriately increased.

In addition, in a case where the spreadability of the wet granules is low, spot-like or streaky thin spots are generated in the negative electrode mixture layer. That is, a negative electrode plate with desired quality cannot be produced. Contrary to this, in this embodiment, since the spreadability of the wet granules is high, the thickness of the negative electrode mixture layer of the negative electrode plate formed in the film forming process can be caused to be uniform. Accordingly, the negative electrode plate 100 with high quality can be produced.

### Second Embodiment

Next, a second embodiment will be described. The production of a negative electrode plate of a lithium-ion secondary battery is also applied to the second embodiment as in the first embodiment. In addition, the configuration of the produced negative electrode plate also has a negative electrode current collector foil and a negative electrode mixture layer in the second embodiment as in the first embodiment. The second embodiment is different from the first embodiment in a procedure for forming wet granules. Hereinafter, the second embodiment will be described in detail.

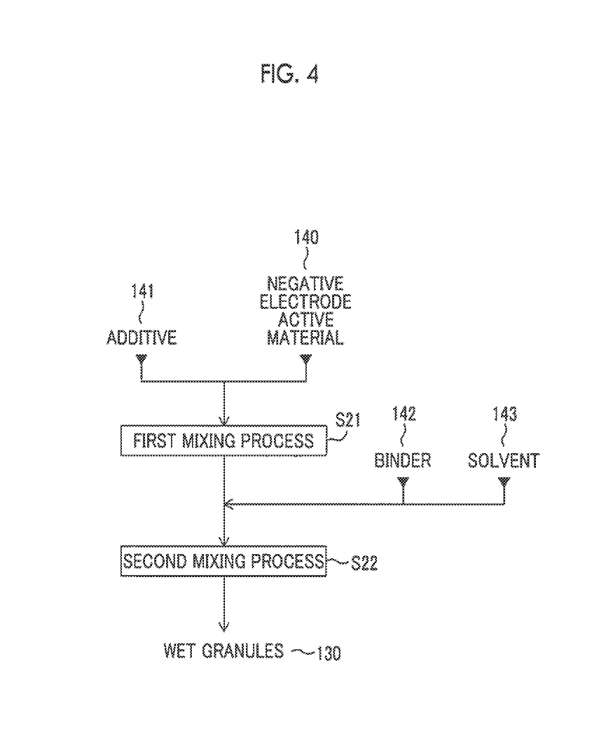

In this embodiment, the negative electrode plate is also produced in the procedure shown in FIG. 1 as in the first embodiment. However, this embodiment is different from the first embodiment in the wet granule forming process (S1). FIG. 4 is a flowchart showing a procedure for forming wet granules in a wet granule forming process of this embodiment.

As shown in FIG. 4, in this embodiment, the negative electrode active material 140, the additive 141, and the binder 142 are also used as negative electrode mixture materials to form the wet granules 130. In addition to the negative electrode mixture materials, the solvent 143 is also used in this embodiment to form the wet granules 130. As the negative electrode active material 140, the additive 141, the binder 142, and the solvent 143, the same materials as those in the first embodiment may be used.

That is, in this embodiment, as one of the negative electrode mixture materials, copper powder in which the average particle size of primary particles is 100 nm or smaller is also used. Furthermore, in this embodiment, the amount of the additive 141 added is also set to be in a range of 0.05 wt % to 2.00 wt % with respect to the total weight of the negative electrode mixture materials (the negative electrode active material 140, the additive 141, and the binder 142).

In addition, in the wet granule forming process of this embodiment, as shown in FIG. 4, first, a first mixing process (S21) of mixing the negative electrode active material 140 and the additive 141 is performed. The first mixing process can be performed by supplying the negative electrode active material 140 and the additive 141 into a stirrer and stirring the resultant. In this embodiment, as the stirrer, the same stirrer as that in the first embodiment is also used. In the first mixing process, through the stirring, the negative electrode active material 140 and the additive 141 are uniformly dispersed in the mixture.

Next, a second mixing process (S22) is performed. In the second mixing process, the binder 142 and the solvent 143 are mixed in the mixture of the negative electrode active material 140 and the additive 141 produced in the first mixing process (S21). The second mixing process can be performed by additionally supplying the binder 142 and the solvent 143 into the stirrer in which the mixture of the negative electrode active material 140 and the additive 141 is stirred. Through the stirring, the negative electrode active material 140, the additive 141, the binder 142, and the solvent 143 are uniformly dispersed in the mixture.

Furthermore, in the second mixing process, as the mixture of the negative electrode active material 140 and the like are stirred, the materials in the mixture are granulated. That is, in this embodiment, in the second mixing process, the wet granules 130 are formed.

In addition, even in this embodiment, the proportion of the solid content in the wet granules 130 is preferably 70% or higher. In addition, in this embodiment, the proportion of the solid content in the wet granules 130 is also preferably 90% or lower and more preferably 85% or lower.

In addition, using the obtained wet granules 130, the film forming process (S2) shown in FIG. 1 is performed. In this film forming process of this embodiment, the film forming apparatus 1 described with reference to FIG. 3 may also be used. That is, in this embodiment, the film forming process may be performed in the same manner as in the first embodiment. Accordingly, the negative electrode plate 100 can be produced.

Here, in this embodiment, the wet granules are formed in a different manner from that of the first embodiment are used. Specifically, the first mixing process mixes the negative electrode active material and the fine particle powder of copper before supplying the binder and the solvent. Thereafter, the second mixing process supplies the binder and the solvent and mixes the resultant mixture of the negative electrode active material and the fine particles powder of copper from the first mixing process.

In addition, since the first mixing process is performed first, in the mixture produced in the subsequent second mixing process, the fine particle powder of copper is caused to be further dispersed. This is because, since the solvent is added after the negative electrode active material and the fine particle powder of copper are mixed together, agglomeration of the fine particle powder of copper can be further suppressed.

Accordingly, in this embodiment, the wet granules can achieve lower spreadability. This is because the wet granules include the uniformly dispersed fine particle powder of copper. Therefore, in this embodiment, in the film forming process, a negative electrode mixture layer with a more uniform thickness can be formed.

Furthermore, in this embodiment, since the wet granules in which the fine particle powder of copper is further uniformly dispersed, the formed negative electrode mixture layer can include the fine particle powder of copper uniformly dispersed in the negative electrode mixture layer. In addition, copper is a material with high conductivity. Therefore, the negative electrode mixture layer can obtained having higher conductivity. That is, a battery produced using the negative electrode plate according to this embodiment can be produced having low internal resistance.

Examples of the disclosure will be described together with comparative examples. All the comparative examples are different from the disclosure. In addition, in the examples and the comparative examples, first to third tests were conducted. Hereinafter, this will be described in order from the first test.

First, the first test was conducted on Examples 1 to 4 shown in Table 1 below. Among these, Examples 1 to 3 are associated with the second embodiment described above. That is, in Examples 1 to 3, the wet granule forming process was performed in the procedure shown in FIG. 4. In addition, Example 4 is associated with the first embodiment described above. That is, in Example 4, the wet granule forming process was conducted in the procedure shown in FIG. 2.

As fine particle powder of copper as an additive, specifically, NANO PURE copper nanopowder (average particle size: 100 nm) manufactured by JAPAN ION Corporation was used. Furthermore, the compositional ratio in the wet granules was set as follows in terms of weight ratio.

Negative electrode active material:copper powder:binder=95−X:X:5

In addition, in the compositional ratio in the wet granules, “X” is specifically described in “addition amount X” in Table 1 as follows.

TABLE 1

| | | Average | Addition | Wet |
|---|---|---|---|---|
| | | particle | amount | granule |
| | | size | X | forming |
| | Additive | [nm] | [wt %] | process |
| Example 1 | Cu | 100 | 0.05 | FIG. 4 |
| Example 2 | Cu | 100 | 0.10 | FIG. 4 |
| Example 3 | Cu | 100 | 2.00 | FIG. 4 |
| Example 4 | Cu | 100 | 0.10 | FIG. 2 |
| Comparative | Absent | — | 0 | FIG. 2 |
| Example 1 | | | | |
| Comparative | Cu | 100 | 5.00 | FIG. 4 |
| Example 2 | | | | |
| Comparative | Cu | 500 | 0.10 | FIG. 4 |
| Example 3 | | | | |
| Comparative | Cu | 1000 | 0.10 | FIG. 4 |
| Example 4 | | | | |

In addition, in Comparative Example 1, as shown in Table 1, unlike Examples 1 to 4, wet granules were formed without using the fine particle powder of copper as an additive. That is, the wet granules of Comparative Example 1 were formed by the negative electrode active material, the binder, and the solvent. In Comparative Example 2, the amount of the fine particle powder of copper added was set to be more than 2.00 wt %, which is outside of the range of 0.05 wt % to 2.00 wt %. Furthermore, in Comparative Examples 3 and 4, powder of copper having an average particle size of greater than 100 nm was used as the additive. Conditions for Comparative Examples 1 to 4 other than those described above are the same as those in Examples 1 to 4.

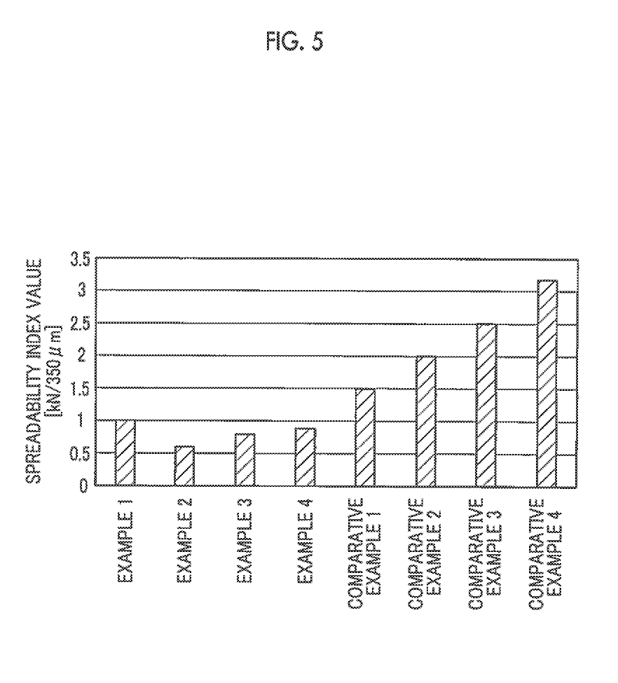

In addition, in the first test, the spreadabilities of the wet granules formed in Examples 1 to 4 and Comparative Examples 1 to 4 were compared to each other. FIG. 5 is a graph showing the spreadability index values of Examples 1 to 4 and Comparative Examples 1 to 4 obtained in the first test.

In addition, the spreadability index value is a measurement value obtained by a spreadability evaluation apparatus manufactured by RIX CORPORATION. The spreadability evaluation apparatus can press and roll the wet granules by interposing a predetermined amount of the wet granules between a plate member and a wedge member and pushing the wedge member. In addition, in the first test, a load obtained when the thickness of the wet granules rolled by the spreadability evaluation apparatus reached 350 mm was measured, and the measurement value was determined as the spreadability index value of the wet granules. That is, the first test shows that as the spreadability index value decreases, higher spreadability is achieved.

As illustrated in FIG. 5, in Comparative Example 2, a higher spreadability index value was obtained and thus the wet granules obtained lower spreadability compared to Comparative Example 1 in which the wet granules were formed without the addition of the fine particle powder of copper. It is thought that this is because the amount of the fine particle powder of copper added in Comparative Example 2 was excessive. That is, it is thought that fine particles of copper that were excessively present formed aggregates during the mixing in the wet granule forming process, and the spreadability was decreased due to the aggregates.

In addition, as shown in Table 5, in Comparative Examples 3 and 4, higher spreadability index values were obtained and the wet granules obtained lower spreadability than those in Comparative Example 1. In Comparative Examples 3 and 4, the particle sizes of the powder of copper were large. Therefore, it is thought that the frictional resistance between the particles of the solid contents in the wet granules was conversely increased.

Contrary to this, in all of Examples 1 to 4, lower spreadability index values were obtained and the wet granules obtained higher spreadability than those in Comparative Example 1. In all of Examples 1 to 4, in the wet granule forming process, the fine particle powder of copper having an average particle size of 100 nm or smaller was added in a proportion in a range of 0.05 wt % to 2.00 wt %. Therefore, it is thought that the frictional resistance between the particles of the solid contents in the wet granules was caused to be appropriately low.

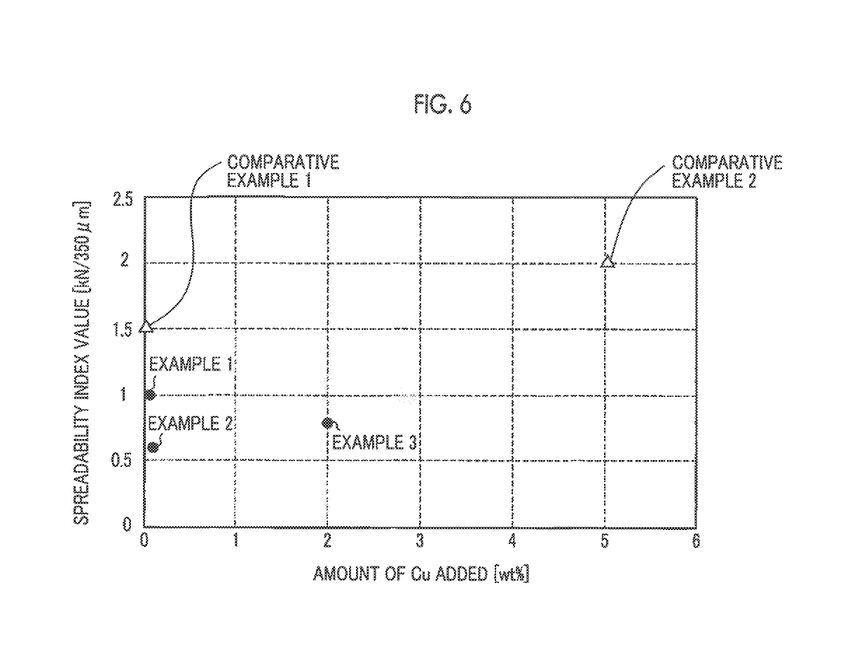

In addition, FIG. 6 is a graph showing the relationship between the amount of the fine particle powder of copper added and the spreadability index value obtained in the first test. FIG. 6 shows Examples 1 to 3 and Comparative Example 2 each in which the wet granules were formed in the wet granule forming process in the same procedure using the fine particle powder of copper of 100 nm or smaller.

From the tendency in FIG. 6, it can be seen that it is not preferable that the amount of the fine particle powder of copper added is too large or too small. That is, in Comparative Example 2 in which the amount of the fine particle powder of copper added was 2.00 wt % or more, a higher spreadability index value and lower spreadability were obtained. In addition, in Example 1 in which the amount of the fine particle powder of copper added was 0.05 wt %, a higher spreadability index value and lower spreadability than those of Example 2 in which the amount of the fine particle powder of copper added was 0.10 wt % were obtained. From this, it is thought that when the addition amount was in a range of 0.10 wt % or less, an effect of increasing the spreadability due to the fine particle powder of copper was decreased as the addition amount was decreased. That is, it is thought that in a case where the amount of the fine particle powder of copper added was set to be less than 0.05 wt %, the spreadability index value is further higher than that in Example 1 and becomes a value close to that of Comparative Example 1. Therefore, from the tendency in FIG. 6, it was confirmed that by causing the amount of the fine particle powder of copper added to be in a range of 0.05 wt % to 2.00 wt %, the spreadability of the wet granules can be appropriately increased.

Next, the second test will be described. The second test was conducted on Examples 1 to 4 in which the wet granule forming process was performed as described above. In addition, in Examples 1 to 4 associated with the second test, lithium-ion secondary batteries were further produced using the wet granules. That is, the film forming process was performed by supplying the formed wet granules into the film forming apparatus (FIG. 3), thereby producing a negative electrode plate. In addition, an electrode assembly was produced by laminating the produced negative electrode plate with a positive electrode plate and a separator. Furthermore, the lithium-ion secondary battery was produced by laminating the produced electrode assembly with a non-aqueous electrolyte formed by dissolving a lithium salt.

The lithium-ion secondary batteries of Examples 1 to 4 were produced in the same manner using the same materials including the positive electrode plate, the separator, and the electrolyte except that the negative electrode plate. In addition, the positive electrode plate was produced by using an aluminum foil as a positive electrode current collector foil. In addition, for the formation of a positive electrode mixture layer of the positive electrode plate, lithium nickel manganese cobalt oxide (LiNi_{1/3}Co_{1/3}Mn_{1/3}O₂) was used as a positive electrode active material, acetylene black (AB) was used as a conductive material, and polyvinylidene fluoride (PVdF) was used as the binder.

In addition, the second test was also conducted on Comparative Examples 5 to 9 for comparison to Examples 1 to 4. In Comparative Examples 5 to 9, unlike Examples 1 to 4, additives shown in Table 2 were used in the wet granule forming process. In addition, the other conditions in Comparative Examples 5 to 9 are also the same as those of Examples 1 to 4.

TABLE 2

| | | Average | Addition | Wet |
|---|---|---|---|---|
| | | particle | amount | granule |
| | | size | X | forming |
| | Additive | [nm] | [wt %] | process |
| Example 1 | Cu | 100 | 0.05 | FIG. 4 |
| Example 2 | Cu | 100 | 0.10 | FIG. 4 |
| Example 3 | Cu | 100 | 2.00 | FIG. 4 |
| Example 4 | Cu | 100 | 0.10 | FIG. 2 |
| Comparative | SiO₂ | 16 | 0.20 | FIG. 4 |
| Example 5 | | | | |
| Comparative | SiO₂ | 7 | 0.20 | FIG. 4 |
| Example 6 | | | | |
| Comparative | Al₂O₃ | 13 | 0.05 | FIG. 4 |
| Example 7 | | | | |
| Comparative | Al₂O₃ | 13 | 1.00 | FIG. 4 |
| Example 8 | | | | |
| Comparative | Al₂O₃ | 13 | 2.00 | FIG. 4 |
| Example 9 | | | | |

That is, in Comparative Examples 5 and 6 the additives for the wet granules were fine particle powders of silicon dioxide (SiO₂) with different average particle sizes. In addition, in Comparative Examples 7 to 9the additives for the wet granules different amounts of the fine particle powder of aluminum oxide (Al₂O₃) were used. The fine particle powders of silicon dioxide and aluminum oxide used in Comparative Examples 5 to 9 are additives that can increase the spreadability of the wet granules.

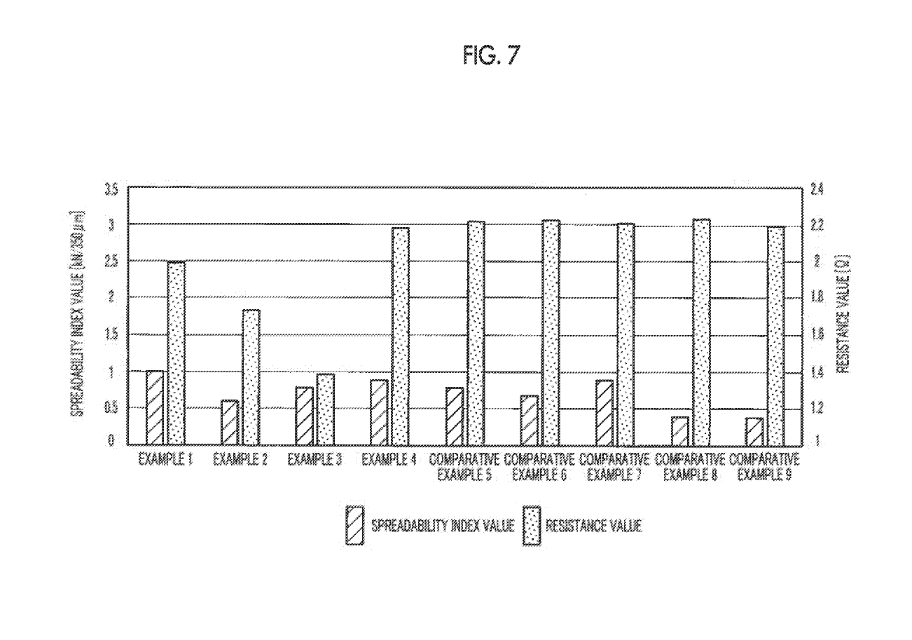

In addition, in the second test, the spreadabilities of the wet granules formed in Examples 1 to 4 and Comparative Examples 5 to 9 were compared to each other. In addition, the internal resistance values of the batteries produced in Examples 1 to 4 and Comparative Examples 5 to 9 were compared to each other. FIG. 7 is a graph showing the spreadability index values and resistance values of Examples 1 to 4 and Comparative Examples 5 to 9 obtained in the second test.

Even in the second test, the spreadability index value is a value acquired in the same manner as in the first test. In the second test, as the spreadability index value decreases, higher spreadability is achieved. The resistance value is a measurement value obtained by measuring the impedance reaction resistance (IV characteristics) for each of the batteries produced in Examples 1 to 4 and Comparative Examples 5 to 9 in an environment at −10 C and a SOC of 56%.

As illustrated in FIG. 7, in all of Examples 1 to 4, low spreadability index values were obtained, and the spreadabilities of the wet granules were high. This is as described in the first test. In addition, even in Comparative Examples 5 to 9, the spreadability index values were equivalent to those of Examples 1 to 4, and the spreadabilities of the wet granules were high. This is because the wet granules were also formed by adding the additives for increasing the spreadability in the wet granules in Comparative Examples 5 to 9.

However, in all of Comparative Examples 5 to 9, the resistance values of the batteries were high. This is because silicon dioxide or aluminum oxide used as the additive in Comparative Examples 5 to 9 does not have high conductivity.

On the other hand, in Examples 1 to 3, the batteries have low resistance values. This is because copper used as the additive in the Examples 1 to 3 has a higher conductivity than that of silicon dioxide or aluminum oxide. However, in Example 4 in which the fine particle powder of copper was used as the additive as in Examples 1 to 3, the resistance value of the battery is not so low. Therefore, it is thought that in Example 4, the distribution of the fine particle powder of copper in the negative electrode mixture layer is different from those of Examples 1 to 3. That is, it is thought that in Examples 1 to 3, the fine particle powder of copper as the additive is appropriately distributed in the negative electrode mixture layer. On the other hand, in Example 4, the fine particle powder of copper as the additive is inappropriately distributed in the negative electrode mixture layer. This will be described by the subsequent third test.

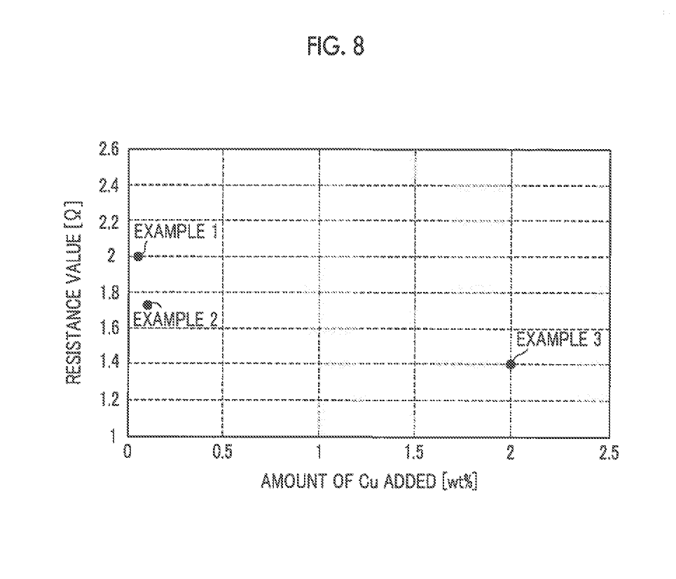

FIG. 8 is a graph showing the relationship between the amount of the fine particle powder of copper added and the resistance value obtained in the second test. FIG. 8 shows Examples 1 to 3 in which the wet granules were formed in the wet granule forming process by the same procedure.

In addition, from the tendency in FIG. 8, it can be seen that it is not preferable that the amount of the fine particle powder of copper added is too large or too small. In Example 1 in which the amount of the fine particle powder of copper added was 0.05 wt %, a higher resistance value was obtained than that in Example 2 in which the amount of the fine particle powder of copper added was 0.10 wt %. From this, it is thought that when the addition amount is in a range of 0.10 wt % or less, the effect of the fine particle powder of copper on a reduction in the resistance value of the battery is lowered as the addition amount is reduced. That is, it is thought that when the amount of the fine particle powder of copper added was less than 0.05 wt %, the resistance value becomes a higher value than that of Example 1. Therefore, from the tendency in FIG. 8, it was confirmed that by setting the amount of the fine particle powder of copper added to 0.05 wt % or more, the resistance value in the battery can be appropriately reduced.

Next, the third test will be described. In the third test, the lithium-ion secondary batteries according to Examples 2 and 4 were used. Moreover, in the third test, the ratio of copper in the negative electrode mixture layer of the negative electrode plate of Examples 2 and 4 was obtained. The ratio of copper was determined by bisecting the negative electrode mixture layer in the negative electrode plate in the thickness direction thereof into a current collector foil side close to the negative electrode current collector foil and a surface side oriented farther from the negative electrode current collector foil than the current collector foil side, and determining the ratio of copper particles present on the surface side to the ratio of copper particles present on the current collector foil side.

In addition, the ratio of copper particles present on each of the current collector foil side and the surface side in the negative electrode mixture layer was determined by cutting the negative electrode mixture layer in the thickness direction thereof, and performing measurement on the section using a scanning electron microscope (SEM) and an energy dispersive fluorescent X-ray analyzer (EDX). That is, mapping of copper was performed on the section of the negative electrode mixture layer, and from the mapped image, the ratio of copper present on each of the current collector foil side and the surface side in the negative electrode mixture layer was obtained. In addition, as shown in Table 3 below, Examples 2 and 4 show different copper ratios.

Furthermore, the third test was also conducted on Examples 5 and 6 in addition to Examples 2 and 4. In Examples 5 and 6, a granulation method in the wet granule forming process, and drying conditions in a process of drying the negative electrode plate after the film forming process were changed. Specifically, for example, the process of drying the negative electrode plate after the film forming process in Examples 5 and 6 was simultaneously conducted at a temperature higher than that of Example 2. Accordingly, in Examples 5 and 6, negative electrode plates having a negative electrode mixture layer with different copper ratios from those of Examples 2 and 4 were produced. Furthermore, using the negative electrode plates, lithium-ion secondary batteries were produced. In Examples 5 and 6, production conditions for the lithium-ion secondary batteries other than the negative electrode plates were also the same as those in Example 2.

In addition, the third test was also conducted on Comparative Examples 10 and 11 for comparison to Examples 2 and 4 to 6. In Comparative Examples 10 and 11, negative electrode mixture layers were formed by a paste method without using wet granules. Specifically, in Comparative Examples 10 and 11, a negative electrode mixture paste was produced by dispersing a negative electrode active material, fine particle powder of copper, and a binder in a solvent, and after applying the negative electrode mixture paste onto the negative electrode current collector foil, the resultant mixture was dried, thereby producing a negative electrode plate. The proportion of solid contents in the negative electrode mixture paste was lower than that of the wet granules. In addition, as shown in Table 3, in Comparative Examples 10 and 11, by changing the drying conditions of the negative electrode mixture paste, the ratio of copper was changed. Production conditions for lithium-ion secondary batteries other than the negative electrode plates in Comparative Examples 10 and 11 were the same as those of Example 2 and the like.

TABLE 3

| | | | | | Ratio of |
|---|---|---|---|---|---|
| | | Average | Addition | Wet | copper [surface |
| | | particle | amount | granule | side/current |
| | | size | X | forming | collector |
| | Additive | [nm] | [wt %] | process | foil side] |
| Example 2 | Cu | 100 | 0.10 | FIG. 4 | 1.10 |
| Example 4 | Cu | 100 | 0.10 | FIG. 2 | 1.27 |
| Example 5 | Cu | 100 | 0.10 | FIG. 4 | 1.19 |
| Example 6 | Cu | 100 | 0.10 | FIG. 4 | 1.25 |
| Comparative | Cu | 100 | 0.10 | (paste | 1.32 |
| Example 10 | | | | method) | |
| Comparative | Cu | 100 | 0.10 | (paste | 1.40 |
| Example 11 | | | | method) | |

As shown in Table 3, in all of Examples 2 and 4 to 6 and Comparative Examples 10 and 11, the fine particle powders of copper having the same average particle size were used as the additive, and the addition amounts thereof were also the same. However, in Examples 2 and 4 to 6 and Comparative Examples 10 and 11, the formation conditions for the negative electrode mixture layers vary and the ratios of copper in the negative electrode mixture layers of the negative electrode plates vary.

In addition, in the third test, the internal resistance values of the batteries produced in Examples 2 and 4 to 6 and Comparative Examples 10 and 11 were compared to each other. In addition, even in the third test, the resistance value is a value acquired in the same manner as in the second test.

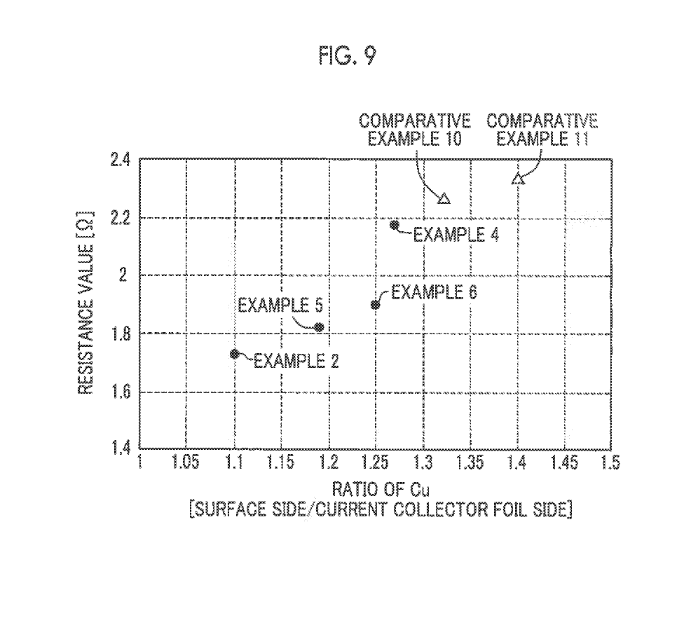

FIG. 9 is a graph showing the relationship between the ratios of copper and the resistance values obtained in the third test. In addition, from the tendency in FIG. 9, it can be seen that the battery has a lower resistance value as a battery in which the ratio of copper is a value closer to 1. Therefore, a battery in which the ratio of copper is a value closer to 1 is preferable. It is thought that this is because as the ratio of copper is a value close to 1, the distribution of copper in the negative electrode mixture layer is uniform in the thickness direction thereof. That is, it can be seen that as the fine particle powder of copper with high conductivity is uniformly distributed in the negative electrode mixture layer, the electrical resistance of the negative electrode mixture layer is low and the internal resistance of the battery can be reduced.

In addition, from FIG. 9, it can be seen that when the ratio of copper is 1.25 or lower, the resistance value is low, and when the ratio of copper becomes 1.25 or higher, the resistance value is significantly increased. From this, it is preferable that ratio of copper of the negative electrode mixture layer is 1.25 or lower. In addition, in all of Examples 2, 5, and 6 in which the ratio of copper is 1.25 or lower, the wet granules were formed in the procedure of the wet granule forming process described with reference to FIG. 4. That is, it was confirmed that by performing the wet granule forming process in the procedure shown in Table 4, the negative electrode mixture layer having high conductivity can be formed.

In addition, in a case where the ratio of copper is much lower than 1, naturally, it is thought that the resistance value of the battery increases. Therefore, it is preferable that the negative electrode mixture layer is formed so that the ratio of copper is in a range of 1-0.25 (in a range of 0.75 to 1.25).

As described above in detail, in this embodiment, the negative electrode plate having the negative electrode mixture layer on the negative electrode current collector foil is produced by the wet granule forming process and the film forming process. In the wet granule forming process, the wet granules are formed by mixing the negative electrode mixture materials including the negative electrode active material and the like with the solvent. In the film forming process, the sheet-shaped negative electrode mixture layer is formed by causing the wet granules to pass through the gap between a pair of the rolls so as to be rolled, and the formed negative electrode mixture layer is adhered onto the negative electrode current collector foil. In addition, in the wet granule forming process, the powder of copper having an average particle size of 100 nm or smaller is used as one of the negative electrode mixture materials. Furthermore, in the wet granule forming process, the amount of the powder of copper added is set to be in a range of 0.05 wt % to 2.00 wt % with respect to the total weight of the negative electrode mixture materials. Accordingly, the production method of the electrode plate in which the electrode mixture layer can be formed with a uniform thickness is realized.

These embodiments are merely examples and do not limit the disclosure at all. Therefore, naturally, various improvements and modifications can be made within the scope that does not depart from the gist of the disclosure. For example, the above-described embodiments are applied to the negative electrode plate of the lithium-ion secondary battery but may also be similarly applied to a positive electrode plate. In addition, the above-described embodiments can be applied not only the electrode plate of the lithium-ion secondary battery but also electrode plates of other secondary batteries.

What is claimed is:

1. A method for producing an electrode plate comprising:
forming wet granules by mixing electrode mixture materials including at least a powder of copper having an average particle size of 100 nm or smaller in a proportion in a range of 0.05 wt % to 2.00 wt % with respect to a total weight of the electrode mixture materials, an active material, and a binder, with a solvent; and
forming a sheet-shaped electrode mixture layer by passing the wet granules through a gap between a pair of rolls so as to be rolled, and adhering the electrode mixture layer onto a current collector foil, thereby producing an electrode plate having the electrode mixture layer on the current collector foil.

2. The production method according to claim 1, further comprising
producing a first mixture by mixing the active material and the powder of copper with each other, and
producing a second mixture by further mixing the binder and the solvent in the first mixture, and granulating the second mixture to form the wet granules.

3. The process of claim 1, wherein said active material is a negative electrode active material that causes occlusion and release of Li ions in a Li-ion battery.

4. The process of claim 3, wherein said negative active electrode material is carbon.

5. The process of claim 4, wherein said current collector foil is formed from copper.

6. The process of claim 1, wherein said electrode plate is an negative electrode plate.

7. The process of claim 6, wherein said electrode mixture layer has a current collector foil side at the negative electrode current foil and a surface side spaced from the negative electrode current collector foil, and where a copper ratio is 0.75 to 1.25 based on copper particles on the surface side of the negative electrode mixture and the currently collector foil side.
